(19) United States
(12) Patent Application Publication
(10) Pub. No.: US 2011/0269913 A1
(43) Pub. Date: Nov. 3, 2011

(54) METHOD FOR PRODUCING TELECHELICS HAVING A WIDE MOLECULAR WEIGHT DISTRIBUTION

(75) Inventors: Sven Balk, Frankfurt (DE); Holger Kautz, Haltern am See (DE); Gerd Loehden, Essen (DE); Lars Zander, Rommerskirchen (DE); Jens Lueckert, Barsinghausen (DE); Johann Klein, Duesseldorf (DE); Thomas Moeller, Duesseldorf (DE); Volker Erb, Duesseldorf (DE)

(73) Assignees: Henkel Ag & Co. KGAA, Duesseldorf (DE); EVONIK ROEHM GMBH, Darmstadt (DE)

(21) Appl. No.: 13/127,533

(22) PCT Filed: Oct. 6, 2009
(86) PCT No.: PCT/EP2009/062931

§ 371 Date: Jul. 21, 2011

(30) Foreign Application Priority Data
Nov. 12, 2008 (DE) 10 2008 043 662.3

(51) Int. Cl. C09D 181/00; C09J 181/00; C08F 8/34

(52) U.S. Cl. 525/350

(57) ABSTRACT

The invention relates to a controlled polymerization method for producing telechelics on the basis of (meth)acrylate, which have a wide, monomodal molecular weight distribution, and to the use thereof as binders in glues or sealing materials.

The invention relates to a controlled polymerization process for preparing (meth)acrylate-based telechelics which have a broad, monomodal molecular weight distribution, and also to the use thereof as binders in adhesives or sealants.

Tailor-made copolymers with defined composition, chain length, molar mass distribution, etc. are a broad field of research. One of the distinctions made is between gradient polymers and block copolymers. A variety of applications are conceivable for such materials. A number of them will be briefly presented below.

Polymers may be prepared, for example, by way of ionic polymerization processes or by polycondensation or polyaddition. In these processes, the preparation of endgroup-functionalized products presents no problems. What does present a problem, however, is a targeted increase in molecular weight.

Polymers obtained through a free-radical polymerization process exhibit molecularity indices of well above 1.8. With a molecular weight distribution of this kind, therefore, there are automatically very short-chain polymers and also long-chain polymers present in the product as a whole. In a melt or in solution, the short-chain polymer chains exhibit a reduced viscosity, while in a polymer matrix they exhibit an increased mobility as compared with long-chain constituents. This has the twin effects first of improved processing properties for such polymers and second of an increased availability of polymer-bonded functional groups in a polymer composition or coating.

Long-chain by-products, in contrast, result in a more-than-proportionate increase in the viscosity of the polymer melt or solution. In addition, the migration of such polymers in a matrix is significantly reduced.

A disadvantage of free-radically prepared binders of this kind, however, is a statistical distribution of functional groups in the polymer chain. Moreover, using a free-radical polymerization method, there is no possibility either of a hard/soft/hard triblock architecture nor of the targeted synthesis of individual polymer blocks having narrow molecular weight distributions.

Suitable living or controlled polymerization methods include not only anionic polymerization or group-transfer polymerization but also modern methods of controlled radical polymerization such as, for example, RAFT polymerization. The ATRP method (atom transfer radical polymerization) was developed in the 1990s significantly by Prof. Matyjaszewski (Matyjaszewski et al., J. Am. Chem. Soc., 1995, 117, p. 5614; WO 97/18247; Science, 1996, 272, p. 866). ATRP yields narrowly distributed (homo)polymers in the molar mass range of Mₙ=10 000-120 000 g/mol. A particular advantage here is that the molecular weight can be regulated. As a living polymerization, furthermore, it allows the targeted construction of polymer architectures such as, for example, random copolymers or else block copolymer structures. Controlled-growth free-radical methods are also suitable particularly for the targeted functionalization of vinyl polymers. Particular interest attaches to functionalizations on the chain ends (referred to as telechelics) or in the vicinity of the chain ends. In contrast, targeted functionalization at the chain end is virtually impossible in the case of radical polymerization.

Binders with a defined polymer design can be made available through a controlled polymerization method, in the form of atom transfer radical polymerization, for example. For instance, ABA triblock copolymers have been described that possess an unfunctionalized B block and functionalized outer A blocks. Polymers of this kind are described in EP 1 475 397 with OH groups, in WO 2007/033887 with olefinic groups, in WO 2008/012116 with amine groups, and in the as yet unpublished DE 102008002016 with silyl groups. All of the polymers described in these specifications, however, have an explicitly narrow molecular weight distribution. Via the so-called controlled polymerization processes, there have been no processes described that would enable polymers to be prepared having individual blocks or a plurality of blocks with a targetedly broad molecular weight distribution.

One method already established is that of end group functionalization of a poly(meth)acrylate with olefinic groups and the subsequent hydrosilylation of these groups. Processes of this kind are found in EP 1 024 153, EP 1 085 027, and EP 1 153 942, as well as others. The products in these specifications, however, are not block copolymers, and there is explicit reference to a molecular weight distribution of less than 1.6 for the product. A further disadvantage of these products as compared with polymers having multiply functionalized outer blocks is the higher probability of obtaining products which at one end are not functionalized. As a result of the lower degree of functionalization that results in each case as compared with the polymers of the invention, the result for further, downstream reactions, such as, for example, in the curing of sealant formulations, is a lower degree of crosslinking, and this runs counter to mechanical stability and chemical resistance.

Besides telechelics and block structures, an alternative is also represented by ATRP-synthesized—e.g., silyl-containing—(meth)acrylate copolymers having a statistical distribution and a narrow molecular weight distribution. A disadvantage of such binders is a close-knit crosslinking. Owing to the narrow molecular weight distribution, as well, binder systems of this kind have the advantages neither of particularly long or particularly short polymer chains present in the system.

Besides ATRP, other methods too are employed for the synthesis of functionalized polymer architectures. A further relevant method will be briefly described below. It is delimited from the present invention in terms both of the products and of the methodology. The advantages of ATRP over other processes are emphasized in particular:

In anionic polymerization, bimodalities may occur.

These polymerization processes, however, are able to generate only certain functionalizations. For ATRP, bimodal distributions have been described for systems. The bimodality of these polymers, however, is a product in each case, first, of the presence of block copolymers and, second, of the presence of unreacted macroinitiators. A disadvantage of these processes is that the product is composed of a mixture of two different polymer compositions.

Problem

A new stage in the development are the telechelics described below. Telechelics are polymers which carry an identical functional group precisely on the two chain ends. For the purposes of this invention they are polymers which have these functional groups on the chain ends to an extent of at least 75%, preferably at least 85%.

The problem addressed was that of providing a process for the synthesis of telechelics which have an overall polydispersity index of at least 1.8.

In one aspect of this invention, a problem addressed was that of providing a process for the synthesis of telechelic triblock polymers of the structure ABA from poly(meth)acrylates. These polymers are to be composed of A blocks with an inherently narrow molecular weight distribution of less than 1.6 and B blocks which have a monomodal, broad molecular weight distribution with not only long polymer chains but also particularly short polymer chains. There is a requirement in particular for ABA triblock copolymers whose B blocks, with a monomodal, broad molecular weight distribution, have a polydispersity index of at least 1.8, and for ABA triblock copolymers comprising these B blocks having an overall polydispersity index of at least 1.8. In this context, ABA triblock copolymers are equated with pentablock copolymers of the composition ACBCA or CABAC.

A parallel problem addressed by this invention was that of providing, with the process step of functionalization, at the same time an industrially realizable process for the removal of transition metal complexes from polymer solutions. The new process is also to be cost-effective and quick to implement. A further problem addressed was that of realizing particularly low residual concentrations of the transition metal complex compounds after just one filtration step.

Solution

The problem has been solved by the provision of a new polymerization process which is based on atom transfer radical polymerization (ATRP). The problem has been solved more particularly through initiation over a relatively long time period, more precisely by the metering of the initiator and the termination of the polymerization through addition of suitable sulfur compounds.

A process is provided for preparing (meth)acrylate polymers which is characterized in that it is an atom transfer radical polymerization (ATRP) where a bifunctional initiator is added to the polymerization solution and in that the (meth)acrylate polymer has a polydispersity index of greater than 1.8. The initiation is commenced with one portion of the initiator, and thereafter a second amount of the initiator is metered in continuously.

Additionally provided is a process in which the addition of suitable functional sulfur compounds brings about termination of the polymerization. Through the choice of suitable sulfur compounds, the respective chain ends are functionalized in the process. At the same time, the terminal halogen atoms are removed from the polymer and the transition metal needed for the polymerization is precipitated almost completely. It can subsequently be removed easily by means of filtration.

One variant of the present invention provides a process for the synthesis of telechelic ABA triblock copolymers having a polydispersity index of greater than 1.8, characterized in that it is a sequentially implemented atom transfer radical polymerization (ATRP) in which a bifunctional initiator is added to the polymerization solution, and in that the block copolymer as a whole and also the block type B has a polydispersity index of greater than 1.8. Through the choice of the method of a sequential polymerization, the process corresponds in this respect to the preparation of polymers without block structure. Through addition of a second monomer mixture A and the possibly subsequent, time-staggered addition of a monomer mixture C, ABA triblock or CABAC pentablock copolymers are constructed. The initiation, the polymerization of the middle block B, and the termination of the polymerization by addition of suitable sulfur compounds take place in the same way as for the preparation of a polymer without block structure. Both structures, therefore, can be considered identical in terms of the description below. The initiation is commenced with one portion of the initiator, and thereafter a second amount of the initiator is metered in continuously.

The block copolymers are prepared by means of a sequential polymerization process. This means that the monomer mixture for the synthesis of the blocks A, for example, is added to the system after a polymerization time t₂ only when the monomer mixture for the synthesis of block B, for example, has already undergone at least 90% reaction, preferably at least 95% reaction. This process ensures that the B blocks are free from monomers of the composition A, and that the A blocks contain less than 10%, preferably less than 5%, of the total amount of the monomers of the composition B. According to this definition, the block boundaries are located at the point in the chain at which the first repeating unit of the added monomer mixture—in this example, of the mixture A—is located. A conversion of only 95% has the advantage that the remaining monomers, especially in the case of acrylates, allow a more efficient transition to the polymerization of a second monomer composition, especially of methacrylates. In this way, the yield of block copolymers is significantly improved.

In the process of the invention, only part of the initiator for the polymerization of the monomer mixture and/or for block copolymers of the monomer mixture B is included in the initial charge, for initiation, and the remainder is metered into the polymer solution over a relatively long time period. With the first batch, the polymerization is initiated. The first initiator charge makes up 10% to 60%, preferably 20% to 40%, of the overall initiator amount. The metered addition of the remaining initiator amount is commenced immediately or, with a slight time stagger, after the onset of an exotherm, but no later than after 10 minutes. Metering takes place over a time period t₁ which may vary according to the target molecular weight. The time t₁ may be between 60 minutes and 6 hours, preferably between 90 minutes and 3 hours. When metering is at an end, polymerization is continued for the polymerization time t₂ before the second monomer mixture A or C is added. As an example, for a target molecular weight of 10 000 g/mol to 40 000 g/mol, t₂ may be between 5 minutes and 6 hours, preferably between 30 minutes and hours. For higher molecular weights, longer polymerization times are absolutely necessary.

Through appropriate choice of the metering time t₁ and of the subsequent polymerization time t₂ it is possible to bring about targeted adjustment of the minimum molecular weight and of the breadth of the molecular weight distribution of the B blocks. The rapid commencement of metering following primary initiation ensures, furthermore, that polymer blocks B are obtained which have a monomodal molecular weight distribution.

In this way, macroinitiators of the composition B are formed for the sequential construction of block copolymers of the composition ABA. These macro-initiators inherently have a molecular weight distribution with a polydispersity index of between 1.8 and 3.0, preferably between 1.9 and 2.5. Following the polymerization time t₂, finally, the monomer mixture A is added. As a result of the nature of ATRP, at this point in time there are both of the previously initiated polymer species of the composition B available for the polymerization, and the polymer blocks A are constructed under the known preconditions for ATRP. These segments of the polymer chains correspondingly exhibit inherently a narrow molecular weight distribution. In the case of pentablock polymers, blocks of type C or D as well may be constructed accordingly.

A further advantage of the present invention is the prevention of recombination. With this process, therefore, the formation of particularly high molecular weights can also be prevented. Such polymer constituents would make a more-than-proportionate contribution to increasing the solution viscosity or melt viscosity. Instead, the broad-distribution, monomodal polymer prepared in accordance with the invention has an innovative polymer distribution. As a result of the inclusion of part of the initiator in the initial charge, for primary initiation, the chains are formed which are subject to the longest polymerization time and hence have the highest molecular weight in the end product. Consequently a polymer is obtained which at high molecular weights still has the characteristics of a polymer prepared by means of controlled polymerization. At low molecular weights, however, the distribution exhibits a sharp broadening of the molecular weight distribution, which is similar to that, or even broader than, the distribution of a product prepared by means of conventional free radical polymerization. The overall molecular weight distribution of the polymers prepared in accordance with the invention has a polydispersity index of greater than 1.8. In accordance with the invention, as a measure of the nonuniformity of the molecular weight distribution, the polydispersity index is reported, as a ratio of the weight average to the number average of the molecular weights. The molecular weights are determined by means of gel permeation chromatography (GPC) against a PMMA standard.

A further constituent of the present invention is the targeted functionalization of the ABA, CABAC, ACBCA or CDBDC block copolymers with broad, monomodal molecular weight distribution at the chain ends. The problem has been solved such that, after ATRP has taken place, the transition metal compound is precipitated through addition of a suitable sulfur compound, and at the same time the chain ends of the polymer are functionalized. The chain ends are functionalized in this way to an extent of at least 75%, preferably at least 85%.

The reagents added in accordance with the invention after or during the termination of polymerization to the polymer solution are preferably compounds which comprise sulfur in organically bonded form. With particular preference these sulfur-containing compounds used to precipitate transition metal ions or transition metal complexes have SH groups and at the same time have a second functional group. With particular preference this second functional group is a hydroxyl, acid or silyl group. The compounds that are more particularly preferred are compounds that are readily available commercially and are used as chain-transfer agents in free-radical polymerization. Advantages of these compounds are their ready availability, their low price, and the broad possibility for variation, allowing optimum adaptation of the precipitating reagents to the particular polymerization system. The present invention cannot, however, be confined to these compounds.

Organic compounds that may be recited include, with very particular preference, functionalized mercaptans and/or other functionalized or else nonfunctionalized compounds which have one or more thiol groups and one or more other functional groups and/or under the solution conditions are able to form such thiol groups and/or one or more other functional groups.

The hydroxy-functional sulfur compounds may be, for example, organic compounds such as mercaptoethanol, mercaptopropanol, mercaptobutanol, mercaptopentanol or mercaptohexanol.

The acid-functional sulfur compounds may be, for example, organic compounds such as thioglycolacetic acid or mercaptopropionic acid.

The silyl-functional sulfur compounds may be, for example, compounds that are readily available commercially and are very important industrially as adhesion promoters, for example. Advantages of these compounds as well are their ready availability and their low price. One example of such a compound is 3-mercaptopropyltrimethoxysilane, which is sold by Evonik Industries under the name DYNALYSAN®-MTMO. Other available silanes are 3-mercaptopropyltriethoxysilane or 3-mercaptopropylmethyldimethoxysilane (sold by ABCR).

The silanes known as α-silanes are particularly reactive. In these compounds, the mercapto group and the silane group are attached to the same carbon atom (R¹, therefore, is generally —CH₂—). Corresponding silane groups of this kind are particularly reactive and in the subsequent formulation may therefore result in a relatively broad spectrum of applications. An example of such a compound is mercaptomethylmethyldiethoxysilane (sold by ABCR).

In free-radical polymerization, the amount of chain-transfer agents, relative to the monomers to be polymerized, is usually stated as 0.05% to 5% by weight. In the present invention, the amount of the sulfur compound used is based not on the monomers but instead on the concentration of the polymerization-active chain ends in the polymer solution. By polymerization-active chain ends are meant the sum of active and dormant chain ends. The sulfur-containing precipitants of the invention are used, in this sense, at 1.5 molar equivalents, preferably 1.2 molar equivalents, more preferably in 1.1 molar equivalents, and very preferably in 1.05 molar equivalents. The amounts of residual sulfur that remain can be removed easily by modifying the subsequent filtration step.

To a person skilled in the art it is easy to see that the mercaptans described, when added to the polymer solution during or after termination of the polymerization, and with the exception of the substitution reaction described, can have no further influence on the polymers. This is true more particularly with regard to the breadth of the molecular weight distributions, the molecular weight, additional functionalities, glass temperature, or melting temperature in the case of partially crystalline polymers, and polymer architectures.

The telechelic polymers and block copolymers of the invention may comprise additional functional groups, which may correspond to the end groups or may be different from these end groups. In block copolymers, these additional functional groups may be incorporated specifically in one or more blocks. The listing below serves only as an example for illustrating the invention, and is not such as to confine the invention in any way whatsoever.

Thus the telechelic polymers may have, for example, additional OH groups.

Hydroxy-functionalized (meth)acrylates suitable for this purpose are preferably hydroxyalkyl (meth)acrylates of straight-chain, branched or cyclo-aliphatic diols having 2-36 C atoms, such as, for example, 3-hydroxypropyl(meth)acrylate, 3,4-dihydroxy-butyl mono(meth)acrylate, 2-hydroxyethyl(meth)-acrylate, 4-hydroxybutyl(meth)acrylate, 2-hydroxy-propyl(meth)acrylate, 2,5-dimethyl-1,6-hexanediol mono(meth)acrylate, more preferably 2-hydroxyethyl methacrylate.

Amine groups are preparable, for example, through the copolymerization of 2-dimethylaminoethyl methacrylate (DMAEMA), 2-diethylaminoethyl methacrylate (DEAEMA), 2-tert-butylaminoethyl methacrylate (t-BAEMA), 2-di-methylaminoethyl acrylate (DMAEA), 2-diethylaminoethyl acrylate (DEAEA), 2-tert-butylaminoethyl acrylate (t-BAEA), 3-dimethylaminopropylmethacrylamide (DMAPMA) and 3-dimethylaminopropylacrylamide (DMAPA).

Polymers with allyl groups may be realized, for example, through the copolymerization of allyl(meth)acrylate. Polymers with epoxy groups through the copolymerization of glycidyl(meth)acrylate. Acid groups may be realized through the copolymerization of tert-butyl(meth)acrylate with subsequent hydrolysis and/or thermal elimination of isobutene.

Examples of (meth)acrylate-bound silyl radicals that may be recited include —SiCl₃, —SiMeCl₂, —SiMe₂Cl, —Si(OMe)₃, —SiMe(OMe)₂, —SiMe₂(OMe), —Si(OPh)₃, —SiMe(OPh)₂, —SiMe₂(OPh), —Si(OEt)₃, —SiMe(OEt)₂, —SiMe₂(OEt), —Si(OPr)₃, —SiMe(OPr)₂, —SiMe₂(OPr), —SiEt(OMe)₂, —SiEtMe(OMe), —SiEt₂(OMe), —SiPh(OMe)₂, —SiPhMe(OMe), —SiPh₂ (OMe) —SiMe(OC(O)Me)₂, —SiMe₂(OC(O)Me), —SiMe(O—N═CMe₂)₂ or —SiMe₂(O—N═CMe₂). Where the abbreviations are as follows: Me stands for methyl-, Ph for phenyl-, Et for ethyl-, and Pr for isopropyl- or n-propyl-. An example of a commercially available monomer is Dynasylan® MEMO from Evonik-Degussa GmbH. This compound is 3-methacryloyloxypropyl-trimethoxysilane.

The (meth)acrylate notation stands for the esters of (meth)acrylic acid and here denotes not only methacrylate, such as methyl methacrylate, ethyl methacrylate, etc., for example, but also acrylate, such as methyl acrylate, ethyl acrylate, etc., for example, and also mixtures of both.

Monomers which are polymerized both in block A and in block B are selected from the group of (meth)acrylates such as, for example, alkyl(meth)acrylates of straight-chain, branched or cycloaliphatic alcohols having 1 to 40 C atoms, such as, for example, methyl(meth)acrylate, ethyl(meth)acrylate, n-butyl(meth)acrylate, isobutyl(meth)acrylate, tert-butyl(meth)acrylate, pentyl(meth)acrylate, 2-ethylhexyl(meth)acrylate, stearyl(meth)acrylate, lauryl(meth)acrylate, cyclohexyl(meth)acrylate, isobornyl(meth)acrylate; aryl(meth)acrylates such as, for example, benzyl(meth)acrylate or phenyl(meth)acrylate which may in each case have unsubstituted or mono- to tetra-substituted aryl radicals; other aromatically substituted (meth)acrylates such as, for example, naphthyl(meth)acrylate; mono(meth)acrylates of ethers, polyethylene glycols, polypropylene glycols or mixtures thereof having 5-80 C atoms, such as, for example, tetrahydrofurfuryl methacrylate, methoxy(m)ethoxyethyl methacrylate, 1-butoxypropyl methacrylate, cyclo-hexyloxymethyl methacrylate, benzyloxymethyl methacrylate, furfuryl methacrylate, 2-butoxyethyl methacrylate, 2-ethoxyethyl methacrylate, allyl-oxymethyl methacrylate, 1-ethoxybutyl methacrylate, 1-ethoxyethyl methacrylate, ethoxymethyl methacrylate, poly(ethylene glycol)methyl ether(meth)acrylate and poly(propylene glycol)methyl ether(meth)acrylate.

Besides the (meth)acrylates set out above it is possible for the compositions to be polymerized also to contain further unsaturated monomers which are copolymerizable with the aforementioned (meth)acrylates and by means of ATRP. These include, among others, 1-alkenes, such as 1-hexene, 1-heptene, branched alkenes such as, for example, vinylcyclohexane, 3,3-dimethyl-1-propene, 3-methyl-1-diisobutylene, 4-methyl-1-pentene, acrylonitrile, vinyl esters such as vinyl acetate, styrene, substituted styrenes with an alkyl substituent on the vinyl group, such as α-methylstyrene and α-ethylstyrene, substituted styrenes with one or more alkyl substituents on the ring such as vinyltoluene and p-methylstyrene, halogenated styrenes such as, for example, monochlorostyrenes, dichloro-styrenes, tribromostyrenes and tetrabromostyrenes; heterocyclic compounds such as 2-vinylpyridine, 3-vinylpyridine, 2-methyl-5-vinylpyridine, 3-ethyl-4-vinylpyridine, 2,3-dimethyl-5-vinylpyridine, vinyl-pyrimidine, 9-vinylcarbazole, 3-vinylcarbazole, 4-vinylcarbazole, 2-methyl-1-vinylimidazole, vinyl-oxolane, vinylfuran, vinylthiophene, vinylthiolane, vinylthiazoles, vinyloxazoles and isoprenyl ethers; maleic acid derivatives, such as, for example, maleic anhydride, maleimide, methylmaleimide and dienes such as divinylbenzene, for example, and also, in the A blocks, the respective hydroxy-functionalized and/or amino-functionalized and/or mercapto-functionalized compounds. Furthermore, these copolymers may also be prepared such that they have a hydroxyl and/or amino and/or mercapto functionality in one substituent. Examples of such monomers include vinylpiperidine, 1-vinyl imidazole, N-vinylpyrrolidone, 2-vinyl-pyrrolidone, N-vinylpyrrolidine, 3-vinylpyrrolidine, N-vinylcaprolactam, N-vinylbutyrolactam, hydrogenated vinylthiazoles and hydrogenated vinyloxazoles. Particular preference is given to copolymerizing vinyl esters, vinyl ethers, fumarates, maleates, styrenes or acrylonitriles with the A blocks and/or B blocks.

The process can be carried out in any desired halogen-free solvents. Preference is given to toluene, xylene, H₂O; acetates, preferably butyl acetate, ethyl acetate, propyl acetate; ketones, preferably ethyl methyl ketone, acetone; ethers; aliphatics, preferably pentane, hexane; biodiesel; but also plasticizers such as low-molecular-mass polypropylene glycols or phthalates.

The block copolymers of the composition ABA are prepared by means of sequential polymerization.

Besides solution polymerization the ATRP can also be carried out as emulsion, miniemulsion, microemulsion, suspension or bulk polymerization.

The polymerization can be carried out under atmospheric, subatmospheric or superatmospheric pressure. The temperature of polymerization is also not critical. In general, however, it is situated in the range from −20° C. to 200° C., preferably from 0° C. to 130° C. and with particular preference from 50° C. to 120° C.

The polymer of the invention preferably has a number-average molecular weight of between 5000 g/mol and 100 000 g/mol, with particular preference between 7500 g/mol and 50 000 g/mol and with very particular preference ≦30 000 g/mol.

As bifunctional initiators there can be RO₂C—CHX—(CH₂)ₙ—CHX—CO₂R, RO₂C—C(CH₃)X—(CH₂)ₙ—C(CH₃)X—CO₂R, RO₂C—CX₂—(CH₂)ₙ—CX₂—CO₂R, RC(O)—CHX—(CH₂)ₙ—CHX—C(O)R, RC(O)—C(CH₃)X—(CH₂)ₙ—C(CH)₃X—C(O)R, RC(O)—CX₂—(CH₂)ₙ—CX₂—C(O)R, XCH₂—CO₂—(CH₂)ₙ—OC(O)CH₂X, CH₃CHX—CO₂—(CH₂)ₙ—OC(O)CHXCH₃, (CH₃)₂CX—CO₂—(CH₂)ₙ—OC(O)CX(CH₃)₂, X₂CH—CO₂—(CH₂)ₙ—OC(O)CHX₂, CH₃CX₂—CO₂—(CH₂)ₙ—OC(O)CX₂CH₃, XCH₂C(O)C(O)CH₂X, CH₃CHXC(O)C(O)CHXCH₃, XC(CH₃)₂C(O)C(O)CX(CH₃)₂, X₂CHC(O)C(O)CHX₂, CH₃CX₂C(O)C(O)CX₂CH₃, XCH₂—C(O)—CH₂X, CH₃—CHX—C(O)—CHX—CH₃, CX(CH₃)₂—C(O)—CX(CH₃)₂, X₂CH—C(O)—CHX₂, C₆H₅—CHX—(CH₂)ₙ—CHX—C₆H₅, C₆H₅—CX₂—(CH₂)ₙ—CX₂—C₆H₅, C₆H₅—CX₂—(CH₂)ₙ—CX₂—C₆H₅, o-, m- or p-XCH₂-Ph-CH₂X, o-, m- or p-CH₃CHX-Ph-CHXCH₃, o-, m- or p-(CH₃)₂CX-Ph-CX(CH₃)₂, o-, m- or p-CH₃CX₂-Ph-CX₂CH₃, o-, m- or p-X₂CH-Ph-CHX₂, o-, m- or p-XCH₂-CO₂-Ph-OC(O)CH₂X, o-, m- or p-CH₃CHX—CO₂-Ph-OC(O)CHXCH₃, o-, m- or p-(CH₃)₂CX—CO₂-Ph-OC(O)CX(CH₃)₂, CH₃CX₂—CO₂-Ph-OC(O)CX₂CH₃, o-, m- or p-X₂CH—CO₂-Ph-OC(O)CHX₂ or o-, m- or p-XSO₂-Ph-SO₂X (X stands for chlorine, bromine or iodine; Ph stands for phenylene (C₆H₄); R represents an aliphatic radical of 1 to 20 carbon atoms, which may be linear, branched or else cyclic in structure, may be saturated or mono- or polyunsaturated and may contain one or more aromatics or else is aromatic-free, and n is a number between 0 and 20). Preference is given to using 1,4-butanediol di(2-bromo-2-methylpropionate), 1,2-ethylene glycol di(2-bromo-2-methylpropionate), diethyl 2,5-dibromo-adipate or diethyl 2,3-dibromomaleate. The ratio of initiator to monomer gives the later molecular weight, provided that all of the monomer is reacted.

Catalysts for ATRP are set out in Chem. Rev. 2001, 101, 2921. The description is predominantly of copper complexes—among others, however, compounds of iron, of rhodium, of platinum, of ruthenium or of nickel are employed. In general it is possible to use any transition metal compounds which, with the initiator, or with the polymer chain which has a transferable atomic group, are able to form a redox cycle. Copper can be supplied to the system for this purpose, for example, starting from Cu₂O, CuBr, CuCl, CuI, CuN₃, CuSCN, CuCN, CuNO₂, CuNO₃, CuBF₄, Cu(CH₃COO) or Cu(CF₃COO).

One alternative to the ATRP described is represented by a variant of it: In so-called reverse ATRP, compounds in higher oxidation states can be used, such as CuBr₂, CuCl₂, CuO, CrCl₃, Fe₂O₃ or FeBr₃, for example. In these cases the reaction can be initiated by means of conventional free-radical initiators such as, for example, AIBN. In this case the transition metal compounds are first reduced, since they are reacted with the radicals generated from the conventional free-radical initiators. Reverse ATRP has been described by, among others, Wang and Matyjaszewski in Macromolecules (1995), vol. 28, p. 7572 ff.

One variant of reverse ATRP is represented by the additional use of metals in the zero oxidation state.

As a result of an assumed comproportionation with the transition metal compounds in the higher oxidation state, an acceleration is brought about in the reaction rate. This process is described in more detail in WO 98/40415.

The molar ratio of transition metal to bifunctional initiator is generally situated in the range from 0.02:1 to 20:1, preferably in the range from 0.02:1 to 6:1 and with particular preference in the range from 0.2:1 to 4:1, without any intention hereby to impose any restriction.

In order to increase the solubility of the metals in organic solvents and at the same time to prevent the formation of stable and hence polymerization-inert organometallic compounds, ligands are added to the system. Additionally, the ligands facilitate the abstraction of the transferable atomic group by the transition metal compound. A listing of known ligands is found for example in WO 97/18247, WO 97/47661 or WO 98/40415. As a coordinative constituent, the compounds used as ligand usually contain one or more nitrogen, oxygen, phosphorus and/or sulfur atoms. Particular preference is given in this context to nitrogen-containing compounds. Very particular preference is enjoyed by nitrogen-containing chelate ligands. Examples that may be given include 2,2′-bipyridine, N,N,N′,N″,N″-pentamethyldiethylenetriamine (PMDETA), tris(2-aminoethyl)amine (TREN), N,N,N′,N′-tetramethylethylenediamine or 1,1,4,7,10,10-hexamethyltriethylenetetramine. Valuable indicators relating to the selection and combination of the individual components are found by the skilled person in WO 98/40415.

These ligands may form coordination compounds in situ with the metal compounds or they may first be prepared as coordination compounds and then introduced into the reaction mixture.

The ratio of ligand (L) to transition metal is dependent on the denticity of the ligand and on the coordination number of the transition metal (M). In general the molar ratio is situated in the range 100:1 to 0.1:1, preferably 6:1 to 0.1:1 and with particular preference 3:1 to 1:1, without any intention hereby to impose any restriction.

When ATRP has taken place, the transition metal compound can be precipitated by the addition of the described sulfur compound. By addition of mercaptans, for example, the halogen atom at the end of the chain is substituted, with release of a hydrogen halide. The hydrogen halide—HBr, for example—protonates the ligand L, coordinated on the transition metal, to form an ammonium halide. As a result of this process, the transition metal-ligand complex is quenched and the “bare” metal is precipitated. After that the polymer solution can easily be purified by means of a simple filtration. The said sulfur compounds are preferably compounds containing an SH group. With very particular preference they are one of the chain transfer agents known from free-radical polymerization.

A broad field of application is produced for these products. The selection of the use examples is not such as to restrict the use of the polymers of the invention. Telechelics with reactive groups may be employed preferably as prepolymers for a moisture-curing crosslinking. These prepolymers can be crosslinked with any desired polymers.

The preferred applications for the telechelics of the invention with, for example, silyl groups are to be found in sealants, in reactive hotmelt adhesives or in adhesive bonding compositions. Particularly appropriate uses are in sealants for applications in the fields of automotive engineering, shipbuilding, container construction, mechanical engineering and aircraft engineering, and also in the electrical industry and in the building of domestic appliances. Further preferred fields of application are those of sealants for building applications, heat-sealing applications or assembly adhesives.

The possible applications for materials produced in accordance with the invention do not, however, include only binders for sealants or intermediates for the introduction of other kinds of functionalities. EP 1 510 550, for example, describes a coating composition whose constituents include acrylate particles and polyurethanes. A polymer of the invention in a corresponding formulation would result in an improvement in the processing properties and crosslinking properties. Conceivable applications are, for example, powder coating formulations.

With the new binders it is possible to prepare crosslinkable one-component and two-component elastomers for example for one of the recited applications. Typical further ingredients of a formulation are solvents, fillers, pigments, plasticizers, stabilizing additives, water scavengers, adhesion promoters, thixotropic agents, crosslinking catalysts, tackifiers, etc.

In order to reduce the viscosity it is possible to use solvents, examples being aromatic hydrocarbons such as toluene, xylene, etc., esters such as ethyl acetate, butyl acetate, amyl acetate, Cellosolve acetate, etc., ketones such as methyl ethyl ketone, methyl isobutyl ketone, diisobutyl ketone, etc. The solvent may be added as early as during the radical polymerization.

Crosslinking catalysts for hydrosilylated binders in a formulation for example with corresponding poly-urethanes are the common organic tin, lead, mercury and bismuth catalysts, examples being dibutyltin dilaurate (e.g. from BNT Chemicals GmbH), dibutyltin diacetate, dibutyltin diketonate (e.g. Metatin 740 from Acima/Rohm+Haas), dibutyltin dimaleate, tin naphthenate, etc. It is also possible to use reaction products of organic tin compounds, such as dibutyltin dilaurate, with silicic esters (e.g. DYNASIL A and 40), as crosslinking catalysts. Also, in addition, titanates (e.g. tetrabutyl titanate, tetrapropyl titanate, etc.), zirconates (e.g. tetrabutyl zirconate, etc.), amines (e.g. butylamine, diethanolamine, octylamine, morpholine, 1,3-diazabicyclo[5.4.6]undec-7-ene (DBU), etc.) and/or their carboxylic salts, low molecular mass polyamides, amino organosilanes, sulfonic acid derivatives, and mixtures thereof.

One advantage of the block copolymers is the colorlessness and also the odorlessness of the product produced. A further advantage of the present invention is the restricted number of functionalities. A higher fraction of functional groups in the binder results in possible premature gelling or at least in an additional increase in the solution viscosity and melt viscosity.

The examples given below are given for the purpose of improved illustration of the present invention, but are not apt to restrict the invention to the features disclosed herein.

### EXAMPLES

The number-average and weight-average molecular weights Mn and Mw and the polydispersity index D=Mw/Mn as a measure of the molecular weight distributions are determined by means of gel permeation chromatography (GPC) in tetrahydrofuran relative to a PMMA standard.

The examples below are confined to the synthesis of ABA triblock copolymers. To a person skilled in the art it is readily apparent that these results can easily be transposed to polymers without block structure or to pentablock copolymers.

### Comparative Example 1

A jacketed vessel equipped with stirrer, thermometer, reflux condenser, nitrogen introduction tube and dropping funnel was charged under an N₂ atmosphere with n-butyl acrylate (precise quantity in table 1), 180 ml of ethyl acetate, copper(I) oxide (for amount see table 1) and N,N,N′,N″,N″-pentamethyldiethylenetriamine (PMDETA, for amount see table 1). The solution is stirred at 70° C. for 15 minutes. Subsequently, at the same temperature, an amount of an initiator 1 (see table 1), 1,4-butanediol di(2-bromo-2-methylpropionate) (BDBIB, total initiator in solution in 26 ml of ethyl acetate) is added. After the polymerization time of three hours a sample is taken for determination of the average molar weight Mₙ (by means of SEC) and a mixture of 100 ml of ethyl acetate and methyl methacrylate (for precise amount see table 2) is added. The mixture is polymerized to an anticipated conversion of at least 95% and is terminated by addition of 2.0 g of mercapto-ethanol and stirred at 75° C. for a further 50 minutes. The solution is worked up by filtration over silica gel and the subsequent removal of volatile constituents by means of distillation. The average molecular weight is determined, finally, by SEC measurements.

### Comparative Example 2

The polymerization takes place in the same way as for comparative example 1, with addition of the amounts specified in table 1. The reaction is terminated with addition of 2.0 g of thioglycolic acid.

### Comparative Example 3

The polymerization takes place in the same way as for comparative example 1, with addition of the amounts specified in table 1. The reaction is terminated with addition of 5.0 g of Dynasylan MTMO.

TABLE 1

| | Comp. Ex. 1 | Comp. Ex. 2 | Comp. Ex. 3 |
|---|---|---|---|
| n-BA | 134.7 g | 135.7 g | 134.5 g |
| Copper(I) oxide | 1.3 g | 1.4 g | 1.3 g |
| PMDETA | 3.5 g | 3.6 g | 3.8 g |
| Initiator1 | 2.6 g | 2.6 g | 2.7 g |
| MMA | 68.2 g | 67.6 g | 67.7 g |
| Mₙ (stage 1) | 19 000 | 18 600 | 20 700 |
| D | 1.40 | 1.25 | 1.24 |
| Mₙ (end product) | 28 600 | 30 400 | 32 700 |
| D | 1.36 | 1.31 | 1.33 |

MMA = methyl methacrylate;
n-BA = n-butyl acrylate

Comparative examples 1 to 3 show that with conventional addition of initiator in one batch, polymers are formed that have relatively narrowly distributed inner blocks and polydispersity indices of less than 1.4.

Following removal of the solvent, the silyl-functionalized products can be stabilized by addition of suitable drying agents. This ensures a good shelf life without further increase in molecular weight.

### Example 1

A jacketed vessel equipped with stirrer, thermometer, reflux condenser, nitrogen introduction tube and dropping funnel was charged under an N₂ atmosphere with n-butyl acrylate (precise quantity in table 1), 180 ml of ethyl acetate, copper(I) oxide (for amount see table 1) and N,N,N′,N″,N″-pentamethyldiethylenetriamine (PMDETA, for amount see table 1). The solution is stirred at 70° C. for 15 minutes. Subsequently, at the same temperature, an amount of an initiator 1 (see table 1), 1,4-butanediol di(2-bromo-2-methylpropionate) (BDBIB, total initiator in solution in 26 ml of propyl acetate) is added. After two minutes, the uniform metered addition of the amount of the initiator 2 (see table 1; in solution in 20 ml of ethyl acetate), 1,4-butanediol di(2-bromo-2-methylpropionate) (BDBIB) is commenced. Metering proceeds without interruption and with a constant metering rate over the time period t₁. Following complete addition of initiator, the polymerization solution is stirred at the polymerization temperature for a time period t₂, before a sample is taken for determination of the average molar weight Mₙ (by means of SEC) and methyl methacrylate (for precise amount see table 1) is added. The mixture is stirred at 75° C. for two hours more and then terminated by addition of 2.0 g of mercaptoethanol. The solution is worked up by filtration over silica gel and the subsequent removal of volatile constituents by means of distillation. The average molecular weight is determined, finally, by SEC measurements.

### Example 2

The polymerization takes place in the same way as for example 1, with addition of the amounts specified in table 2, observing the times indicated there as well. The reaction is terminated with addition of 2.3 g of thioglycolic acid.

### Example 3

The polymerization takes place in the same way as for example 1, with addition of the amounts specified in table 2, observing the times indicated there as well. The reaction is terminated with addition of 4.9 g of Dynasylan MTMO.

TABLE 2

| | Example 1 | Example 2 | Example 3 |
|---|---|---|---|
| n-BA | 136.5 g | 134.4 g | 134.4 g |
| Copper(I) oxide | 1.3 g | 1.3 g | 1.3 g |
| PMDETA | 3.3 g | 3.4 g | 3.4 g |
| Initiator1 | 0.27 g | 0.26 g | 0.26 g |
| Initiator2 | 2.45 g | 2.35 g | 2.35 g |
| t₁ | 180 min | 180 min | 180 min |
| t₂ | 60 min | 30 min | 30 min |
| MMA | 67.7 g | 67.2 g | 67.2 g |
| Mₙ (stage 1) | 18 700 | 20 500 | 20 000 |
| D | 1.91 | 1.94 | 1.86 |
| Mₙ (end product) | 24 100 | 25 100 | 24 300 |
| D | 1.87 | 1.82 | 1.98 |

The molecular weight distributions of the first polymerization stages are in each case monomodal and have a molecularity index D of greater than 1.8. The end products have correspondingly large molecularity indices, albeit smaller than those of the pure B blocks. This effect is a result of the higher molecular weight overall, but also shows that the polymerization of the A blocks is controlled and that the blocks per se have a narrow molecular weight distribution. In the case of endcapping with Dynasylan MTMO, the increase in the molecularity index is attributable to partial dimerization of the polymer chains at the end groups. Through an appropriate experimental regime, this effect, which is not associated with the polymerization process, can easily be prevented.

The transposition of the results to pentablock copolymers of the composition ACBCA or CABAC may take place in an analogous way. The synthesis of such copolymers with narrow distribution is described in, for example, the present applicant's patent application DE 102008002016, not yet laid open.

A transposition of the process to polymers without block structure is also easily achieved. In that case, the addition of mercaptan takes place directly after the end of the polymerization time t₂, instead of the addition of the monomer mixture A.

1-20. (canceled)

21. A process for preparing at least one polymer by a sequentially implemented atom transfer radical polymerization (ATRP), the process comprising
adding a bifunctional initiator for initiating the polymerization to a polymerization solution in a first portion and thereafter adding a second portion continuously; and
functionalizing at least one end of resulting polymer chains by addition of a suitable sulfur compound which has a second functional group,
to obtain a block copolymer of composition ABA, having an overall molecular weight distribution with a polydispersity index of greater than 1.8.

22. The process of claim 21, wherein the initiator is added in two portions:
the first portion of the initiator, accounting for 10% to 60% by weight of an overall amount of initiator, which is added batchwise at a start of the polymerization; and
the second portion of initiator, which is metered in directly after addition of the first portion of the initiator to the polymerization solution, with a constant metering rate.

23. The process of claim 21, wherein the sulfur compound has a second functional group selected from the group consisting of an acid group, hydroxyl group, silyl group, allyl group, and amine group.

24. The process of claim 23, wherein addition of the sulfur compound simultaneously removes halogen atoms at the ends of the polymer chains and precipitates an ATRP catalyst.

25. The process of claim 23, wherein the ends of the polymer chains are functionalized in the functionalizing by addition of the sulfur compound to an extent of at least 75%.

26. The process of claim 21, wherein the polymer is a polyacrylate, a polymethacrylate, or a copolymer of at least two monomers selected from the group consisting of an acrylate and a methacrylate.

27. The process of claim 26, wherein the polymer or at least one block of the polymer additionally comprises at least one selected from the group consisting of an acrylate having an additional functional group and a methacrylate having an additional functional group.

28. The process of claim 26, wherein the polymer or at least one block of the polymer additionally comprises at least one selected from the group consisting of a vinyl ester, a vinyl ether, a fumarate, a maleate, a styrene, an acrylonitrile, and a further monomer which is polymerizable by ATRP.

29. The process of claim 21, wherein the polymer has a number-average molecular weight of between 5000 g/mol and 100 000 g/mol.

30. The process of claim 21, wherein the polymer is a block copolymer.

31. A process for preparing at least one block copolymer with an ABA composition, the comprising:
polymerizing monomers of block B, then polymerizing monomers of block A, wherein
block A is a copolymer having a monomodal molecular weight distribution, and
block B is a copolymer having a monomodal molecular weight distribution with a polydispersity index of greater than 1.8.

32. The process of claim 31, further comprising:
polymerizing monomers of block C either before or after polymerizing monomers of block A, to obtain at least one block copolymer of composition ACBCA or CABAC, wherein block C is a copolymer block having a monomodal molecular weight distribution, and
wherein there are no monomers with further functional groups than a (meth)acrylate in block C.

33. The process of claim 30, wherein the initiator is added in two portions:
the first portion of the initiator accounting for 10% to 60% by weight of an overall amount of the initiator, added batchwise at a start of the polymerization; and
the second portion of the initiator, which is metered in directly after addition of the first portion of the initiator batch to the polymerization solution, with a constant metering rate.

34. The process of claim 33, wherein the second portion of the initiator is metered in over a period of at least 30 minutes and the metering is ended at least 60 minutes before the addition of monomer mixture A and/or C to the polymerization solution.

35. A polymer, obtained by the process of claim 21, comprising, in polymerized form, at least one (meth)acrylate, wherein at least 75% of its chain ends have a functional group which is not a halogen atom,
the polymer having a polydispersity index of greater than 1.8.

36. An ABA triblock copolymer, obtained by the process of claim 31, comprising, in polymerized form, at least one (meth)acrylate,
wherein at least 75% of its chain ends have a functional group which is not a halogen atom,
wherein a polydispersity index of the ABA triblock copolymer is greater than 1.8, but less than the polydispersity index of the block B, and
wherein block B has a broad monomodal molecular weight distribution.

37. A pentablock copolymer of the composition ACBCA or CABAC obtained by the process of claim 32, comprising, in polymerized form, at least one (meth)acrylate,
wherein at least 75% of its chain ends have a functional group which is not a halogen atom,
wherein a polydispersity index of the pentablock copolymer is greater than 1.8, but less than the polydispersity index of the block B, and
wherein block B has a broad monomodal molecular weight distribution.

38. A hotmelt adhesive, fluid adhesive, pressure-sensitive adhesive, elastic sealant, coating material, or foam precursor, comprising the polymer of claim 35.

39. A heat-sealing composition, comprising the polymer of claim 35.

40. A crosslinkable composition comprising the polymer of claim 35, wherein the polymer has at least one reactive functional group.
